(19) United States
(12) Patent Application Publication
(10) Pub. No.: US 2017/0262167 A1
(43) Pub. Date: Sep. 14, 2017

(54) METHOD AND APPARATUS FOR BRUSH INPUT RECOGNITION AND DISPLAY FOR TOUCHSCREEN DEVICES

(71) Applicant: Martin Sanders, Los Angeles, CA (US)

(72) Inventor: Martin Sanders, Los Angeles, CA (US)

(73) Assignee: Pengo Creative Inc., Los Angeles, CA (US)

(21) Appl. No.: 13/981,087

(22) PCT Filed: Jul. 20, 2012
(86) PCT No.: PCT/US12/47753

§ 371 Date: Oct. 23, 2016

Related U.S. Application Data
(60) Provisional application No. 61/510,450, filed on Jul. 21, 2011.
(60) Provisional application No. 61/510,438, filed on Jul. 21, 2011.

(51) Int. Cl. G06F 3/0488; G06F 3/044

(52) U.S. Cl. CPC G06F 3/04883; G06F 3/044; G06F 2203/04105; G06F 2203/04101; G06F 2203/04104

(57) ABSTRACT

A method for recognition and display of one or more inputs for a touch-screen device is disclosed herein. The method includes determining a magnitude of a detected input of a touch-screen portion of the touch-screen device; determining an area of the detected input of the touch-screen portion; and modifying a graphical representation of the detected input based on the area and magnitude of the detected input. An apparatus for implementing the method is also disclosed herein.

### FIELD

The following description relates generally to hardware input devices for computer user interfaces, and more particularly to a method and apparatus for brush input recognition and display for touch-screen devices.

### BACKGROUND

There exist many types of styluses-based user input devices for interacting with touch-screen devices. For drawing or painting software applications, a stylus may be used to draw lines on the screen of the touch-screen device, and the software application would display the lines at the respective touch-screen device locations. These styluses are suitable for drawing lines, but do not emulate brush strokes well. A user typically has to select a “brush” setting in the software application that has a specific radius, and the software application will display a line with a width commensurate with the selected brush size. The brush size is measured in points, or pixel-based measurement units.

For example, if the user selects a brush with a 5-point size and then draws a line on the screen, then the software application will display a line that is 5-point wide where the stylus touched the screen. Styluses having multiple bristles in the shape of a brush have been introduced. However, use of these brush styluses, although emulating the physical feel of a brush, still requires a user to select a brush size in the painting software application before the stylus is used. The brush “stroke” that is displayed on the touch-screen is based on the selected brush size, but has no correlation to the actual size of the brush stylus. Thus, a user may select a brush size of 2-points where the physical size of the brush stylus is 15-points. It would be desirable to have the brush stroke displayed by the touch-screen to be the same physical dimensions of the bristles of the brush stylus.

Consequently, it would be desirable to address one or more of the deficiencies described above.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method for recognition and display of one or more inputs for a touch-screen device, including determining a magnitude of a detected input of a touch-screen portion of the touch-screen device; determining an area of the detected input of the touch-screen portion; and modifying a graphical representation of the detected input based on the area and magnitude of the detected input.

Another aspect of the disclosure provides an apparatus for recognition and display of one or more inputs for a touch-screen device, including means for determining a magnitude of a detected input of a touch-screen portion of the touch-screen device; means for determining an area of the detected input of the touch-screen portion; and means for modifying a graphical representation of the detected input based on the area and magnitude of the detected input.

Another aspect of the disclosure provides an apparatus for recognition and display of one or more inputs for a touch-screen device, including a processor; and a memory coupled to the processor, the memory configured to store instruction code executable by the processor for determining a magnitude of a detected input of a touch-screen portion of the touch-screen device; determining an area of the detected input of the touch-screen portion; and modifying a graphical representation of the detected input based on the area and magnitude of the detected input.

Another aspect of the disclosure provides a computer program product, including a computer-readable storage medium comprising code for determining a magnitude of a detected input of a touch-screen portion of the touch-screen device; determining an area of the detected input of the touch-screen portion; and modifying a graphical representation of the detected input based on the area and magnitude of the detected input.

These and other aspects of the invention will become more fully understood upon a review of the detailed description, which follows.

### BRIEF DESCRIPTION OF THE DRAWINGS

These and other sample aspects of the disclosure will be described in the detailed description that follow, and in the accompanying drawings, wherein:

FIG. 1 is a perspective view of a touch screen/stylus system in which various aspects of the present invention may be implemented;

FIG. 2 is a flow diagram of a basic single-touch input process for a brush configured in accordance with an aspect of the disclosure;

FIG. 3 is a flow diagram of a basic multi-touch input process for a brush configured in accordance with an aspect of the disclosure;

FIG. 4 is a block diagram of a computer system usable for the touch input system.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of a method and apparatus for brush recognition and display for touch-screens are described more fully hereinafter with reference to the accompanying drawings. These aspects may, however, be embodied in many different forms and should not be construed as limited to any specific structure or function presented throughout this disclosure. Rather, these aspects are provided so that this disclosure will be thorough and complete, and will fully convey the scope of these methods and apparatus to those skilled in the art. Based on the descriptions herein teachings herein one skilled in the art should appreciate that that the scope of the disclosure is intended to cover any aspect of the methods and apparatus disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein.

As used herein, the term “brush” refers to a digital representation of a “real” brush that is provided in graphic “paint” or illustration software applications, or programs. Typically, these “paint programs” allow a user to select a brush with a certain size and/or shape, with the size measured in pixels. Thus, for example, a brush with a round shape having a 10-pixel radius will draw a line that is 20-pixels wide on the digital canvas shown on the computer monitor.

Also, as used herein, the term “stylus” refers to any type of input tool usually used with touch sensitive surfaces provided on personal digital assistants (PDAs), graphics tablets, or tablet PCs. “Pen styluses” thus refer to styluses that are in the shape of a pen, with a pointed portion on one end of the stylus that is used to contact the touch-screen. Correspondingly, “brush styluses” refer to styluses that are in the shape of a paint brush, with bristles on one end of the stylus that are used to contact the touch-screen. The styluses are conductive to allow it to operate with capacitive touch-screen devices.

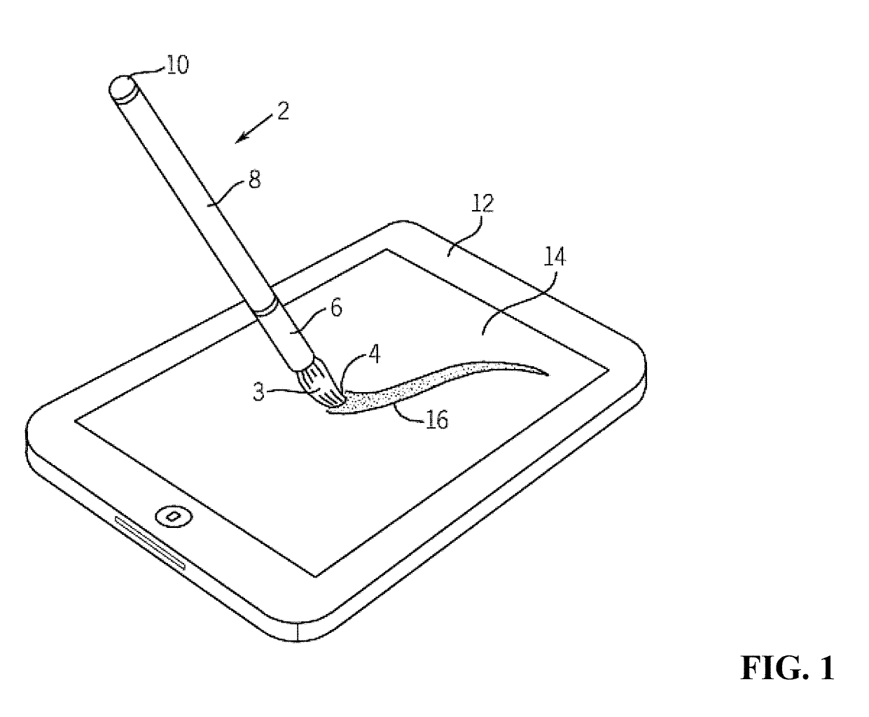

Various aspects of the present invention may be implemented in a system as shown in FIG. 1, where a computer processing device 12 may comprise a projected capacitive touch (PCT) input screen surface (touch screen) 14. In an exemplary embodiment, inputs may be made to the device through the touch screen via a user's finger, conductive stylus, or conductive brush. A brush 2 is illustrated as an example. The touch screen may implement single-touch or multi-touch technology, as further described herein.

In operation, a toe 4 of a brush head 3 may come into contact with the touch screen 14 to provide an input to a software program or application running on the processing device 12. Through the software program or application, the input from the brush 2 may be detected, tracked, and displayed as an on-screen representation of the brush stroke.

In various aspects of the present invention, a user may benefit from the realistic physical feedback and interaction of real physical bristle characteristics between the brush head 3 and the touch screen 14 due to the combination of conductive fibers and filler bristles in the brush head 3. The exemplary embodiments described herein may provide a much close user experience to real painting with real brushes.

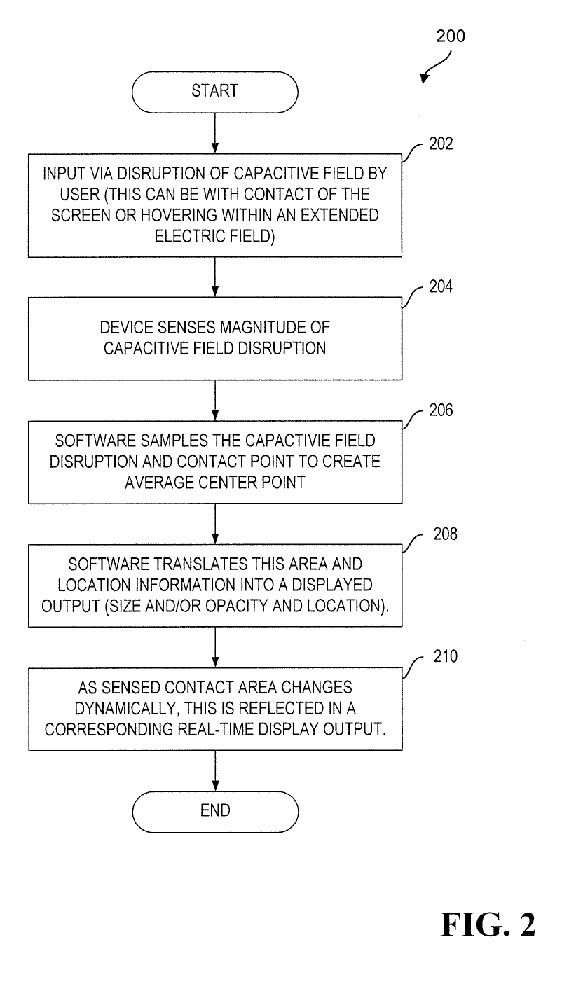

FIG. 2 illustrates a single-touch input process 200 for a software application, such as a paint program, that may operate in a touch-screen device, such as processing device 12. At 202, a user may bring their finger or stylus into a sensing range of a capacitive touch-screen surface of the touch-screen device. The sensing range may vary in distance from the screen surface. Thus, “hovering gestures”, where disruption of the capacitive field that extends out from the touch-screen, may be detected.

At 204, the touch-screen device senses a magnitude of capacitive field disruption. It should be noted that in another aspect of the invention, the touch-screen device may incorporate a pressure sensing mechanism in addition to, or in lieu of, the capacitive sensing mechanism. It should be apparent that the description of the operation of the processes herein may be applicable to a variety of touch-screen technologies.

At 206, the software application samples the capacitive field as an input to the application software. As part of this input, a contact point as well as the average center point is provided. In one aspect of the invention, an application programming interface (API) accessible to the software application may be used to sense and interpret the magnitude of disruption to the capacitive field. This means that the area of the stylus in contact with the screen (or within the field) may be translated into a corresponding input to the software application. In a single-touch scenario (for example using the conductive brush), an average center point to the input is also calculated. In this scenario, the software application detects the average area in contact and the average center point of that contact. From this, the detected input is translated into a corresponding display at 208. With a painting program, this would be based on the radius/size of the brush, as further described herein.

At 210, as the sensed contact area changes dynamically based on a movement of the stylus, the output on the display would be updated to reflect the movement.

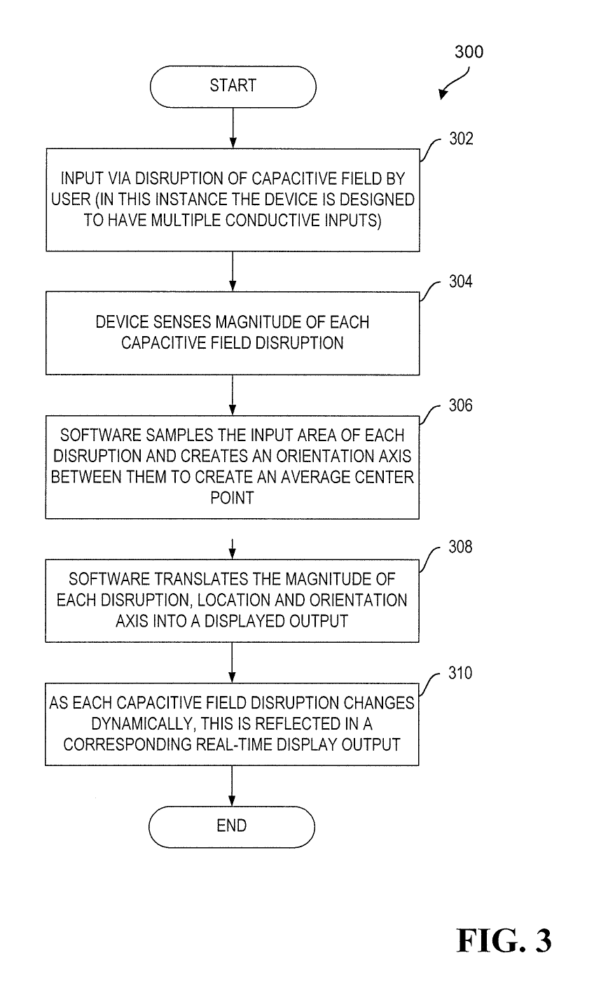

FIG. 3 illustrates a multiple-touch input process 300 for a touch-screen device that has multi-touch detection capabilities, where it would be possible to orient the brush strokes that are displayed. For example, where a brush stylus that has some conductive and non-conductive sections. The principle is that a single brush stylus or input device may provide a multiple point input. Given that the location of these inputs may be sensed, the displayed output may be oriented. An axis may be drawn between two inputs to give the final input a direction.

At 302, an input via disruption capacitive field by the user is made.

At 304, the touch-screen device may sense a magnitude of each capacitive field disruption.

At 306, the software application may sample the input area of each disruption and creates an orientation axis between them to create an average center point. More complex geometries, such as lines or other geometric shapes, may be created based on additional shapes, axes and center points being created.

At 308, the software application translates the magnitude, location, area, and orientation axis of each disruption to create a graphical output. For example, specific shapes or an outline of the area contacted by the brush stylus may be determined using the translated magnitudes, locations, orientation axes, and areas of the various disruptions, and then displayed based on the screen technology or operating system being used.

At 310, as each capacitive field disruption changes dynamically, this is reflected in a corresponding real-time display output.

As discussed above, the brush device can create a small disruption to the capacitive field and this in turn is translated by the software application. An example of the approach used to determine a scale of the brush input from the user and determine what brush size should be used to paint the screen may be represented by the following formulas:

scale=pow(radius−averageRadius, compressingValue); and

brushSize=initialBrushSize*scale;

where:

pow(x, y) is the power function that returns the value of x raised to the power of y;

radius represents the radius of area touched;

averageRadius is the average radius over time;

compressingValue is a value used to compress the value of the difference between the radius and the averageRadius;

initialBrushSize is the size of the paint brush selected in the application; and

brushSize is the size of the brush that should be used to paint the screen.

The software application will update the size of the brush that is being used to paint the screen as the user moves the brush stylus across the touch-screen. As the brush size is scaled and accounts for previous sizes, the displayed stroke changes based on the history and less likely to be erratic. Thus, the screen will display a more realistic representation of the interaction between the brush stylus and the touch-screen. Specifically, the introduction of the scale is to reduce noise. When the compressingValue is less than 1, then the less sensitive the results based on a change of the detected radius will be. For example, if a change of a touch radius is 20, with compression value=1, it will be 20 and the real radius change on the brush will be shown. However, some noise will result because the measured touch radius is not very precise. With a compression value=0.5, the real scale for the examplary change of 20 will only be 4.47.

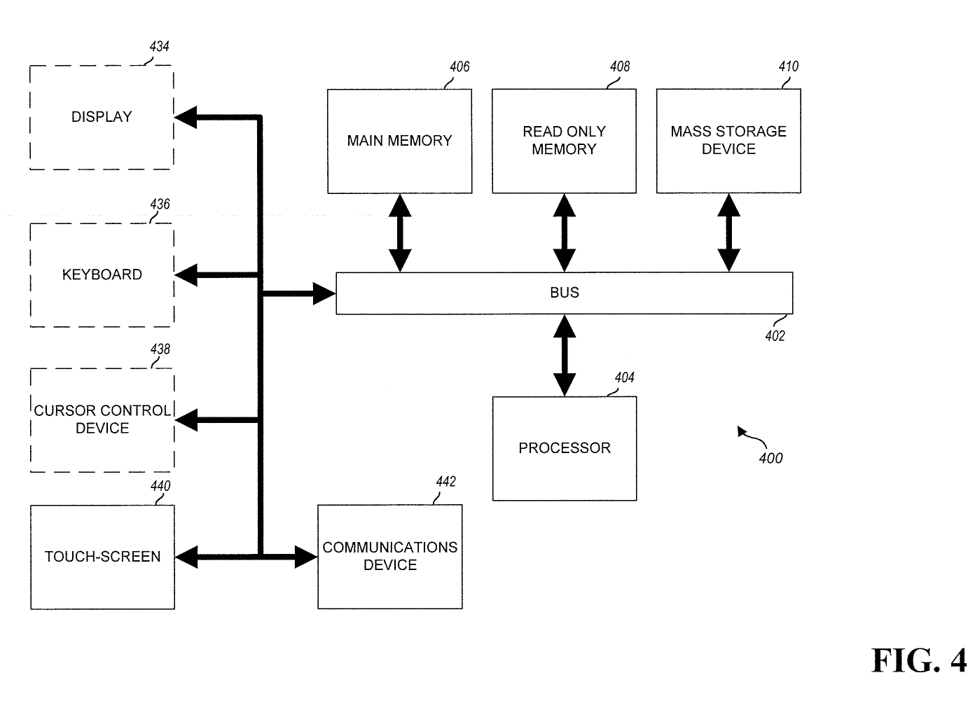

FIG. 4 illustrates an example of a computer system 400 in which certain features of the exemplary brush recognition and display for touch-screen devices may be implemented. Computer system 400 includes a bus 402 for communicating information between the components in computer system 400, and a processor 404 coupled with bus 402 for executing software code, or instructions, and processing information. Computer system 400 further comprises a main memory 406, which may be implemented using random access memory (RAM) and/or other random memory storage device, coupled to bus 402 for storing information and instructions to be executed by processor 404. Main memory 406 also may be used for storing temporary variables or other intermediate information during execution of instructions by processor 404. Computer system 400 also includes a read only memory (ROM) 408 and/or other static storage device coupled to bus 402 for storing static information and instructions for processor 404.

Further, a mass storage device 410, such as a magnetic disk drive and/or a optical disk drive, may be coupled to computer system 400 for storing information and instructions. Computer system 400 can also be coupled via bus 402 to a display device 434, such as a liquid crystal display (LCD) or a cathode ray tube (CRT), for displaying information to a user so that, for example, graphical or textual information may be presented to the user on the display device 434. Typically, an alphanumeric input device 436, such as a keyboard including alphanumeric and other keys, is coupled to bus 402 for communicating information and/or user commands to processor 404. Another type of user input device shown in the figure is a cursor control device 438, such as a conventional mouse, touch mouse, trackball, track pad or other type of cursor direction key for communicating direction information and command selection to processor 404 and for controlling movement of a cursor on display 434. Various types of input devices, including, but not limited to, the input devices described herein unless otherwise noted, allow the user to provide command or input to computer system 400. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 400 may optionally include such devices as a video camera, speakers, a sound card, or many other conventional computer peripheral options.

In addition to, or in place of, the alphanumeric input device 436 or the cursor control device 438, a touch-screen 440 may be used. The touch-screen 440 is configured to receive the user input of “brush strokes” described above using capacitive and/or pressure sensing technology. The touch-screen 440 also provides a display that provides the functionality of the display device 434. In one aspect of the invention, the computer system 400 may be implemented as a tablet computer that includes the touch-screen 440 as its primary input and display element. Hence, the alphanumeric input device 436, the cursor control device 438, and the display device 434 are optional.

A communication device 442 is also coupled to bus 402 for accessing other computer systems or networked devices. Communication device 440 may include a modem, a network interface card, or other well-known interface devices, such as those used for interfacing with Ethernet, Token-ring, or other types of networks. In this manner, computer system 400 may be coupled to a number of other computer systems.

The processing system described herein, or any part of the processing system, may provide the means for performing the functions recited herein. By way of example, the processing system executing code may provide the means for performing the steps in FIGS. 2 and 3. Alternatively, the code on the computer-readable medium may provide the means for performing the functions recited herein.

It is understood that any specific order or hierarchy of steps described in the context of a software module is being presented to provide an examples of a brush input recognition and display approach for a touch-screen device. Based upon design preferences, it is understood that the specific order or hierarchy of steps may be rearranged while remaining within the scope of the disclosure.

Those skilled in the art will recognize how best to implement the described functionality presented throughout this disclosure depending on the particular application and the overall design constraints imposed on the overall system.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both storage media, and communication media including any medium that facilitates transfer of a computer program from one place to another. A storage media may be any available storage media that may be accessed by a computer. By way of example, and not limitation, such computer-readable storage media may include RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Thus, in some aspects, computer-readable medium may comprise non-transitory computer-readable medium (e.g., tangible media such as storage media). In addition, in some aspects, computer-readable medium may include transitory computer-readable medium (e.g., a signal). Combinations of the above should also be included within the scope of computer-readable media.

The previous description is provided to enable any person skilled in the art to fully understand the full scope of the disclosure. Modifications to the various configurations disclosed herein will be readily apparent to those skilled in the art.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for recognition and display of one or more inputs for a touch-screen device, comprising:
determining a magnitude of a detected input of a touch-screen portion of the touch-screen device;
determining an area of the detected input of the touch-screen portion; and
modifying a graphical representation of the detected input based on the area and magnitude of the detected input.

2. The method of claim 1, wherein the determining the magnitude of the detected input comprises detecting a magnitude of a capacitive field disruption.

3. The method of claim 1, wherein the determining the area of the detected input comprises determining at least one of a contact point and an average center point.

4. The method of claim 1, further comprising:
determining a magnitude of a second detected input of the touch-screen portion of the touch-screen device; and
determining an area of the second detected input of the touch-screen portion;
wherein the modifying of the graphical representation of the detected input further comprises modifying the graphical representation based on the detected input and the second detected input.

5. The method of claim 4, further comprising determining an orientation axis based on the magnitude of the first detected input, the magnitude of the second detected input, the area of the first detected input, and the area of the second detected input; and wherein the modifying the graphical representation based on the detected input and the second detected input comprises modifying the graphical representation based on the determined orientation axis.

6. The method of claim 1, further comprising determining a scale of a graphical representation of a brush on the touch-screen device based on the area and magnitude of the detected input.

7. An apparatus for recognition and display of one or more inputs for a touch-screen device, comprising:
means for determining a magnitude of a detected input of a touch-screen portion of the touch-screen device;
means for determining an area of the detected input of the touch-screen portion; and
means for modifying a graphical representation of the detected input based on the area and magnitude of the detected input.

8. The apparatus of claim 117, wherein the means for determining the magnitude of the detected input comprises means for detecting a magnitude of a capacitive field disruption.

9. The apparatus of claim 7, wherein the means for determining the area of the detected input comprises means for determining at least one of a contact point and an average center point.

10. The apparatus of claim 7, further comprising:
means for determining a magnitude of a second detected input of the touch-screen portion of the touch-screen device; and
means for determining an area of the second detected input of the touch-screen portion;
wherein the means for modifying of the graphical representation of the detected input further comprises means for modifying the graphical representation based on the detected input and the second detected input.

11. The apparatus of claim 10, further comprising means for determining an orientation axis based on the magnitude of the first detected input, the magnitude of the second detected input, the area of the first detected input, and the area of the second detected input; and wherein the means for modifying the graphical representation based on the detected input and the second detected input comprises means for modifying the graphical representation based on the determined orientation axis.

12. The apparatus of claim 117, further comprising determining a scale of a graphical representation of a brush on the touch-screen device based on the area and magnitude of the detected input.

13. An apparatus for recognition and display of one or more inputs for a touch-screen device, comprising:
a processor; and
a memory coupled to the processor, the memory configured to store instruction code executable by the processor for:
determining a magnitude of a detected input of a touch-screen portion of the touch-screen device;
determining an area of the detected input of the touch-screen portion; and
modifying a graphical representation of the detected input based on the area and magnitude of the detected input.

14. A computer program product, comprising:
a computer-readable storage medium comprising code for:
determining a magnitude of a detected input of a touch-screen portion of the touch-screen device;
determining an area of the detected input of the touch-screen portion; and
modifying a graphical representation of the detected input based on the area and magnitude of the detected input.
